(19) United States
(12) Patent Application Publication
(10) Pub. No.: US 2021/0039295 A1
(43) Pub. Date: Feb. 11, 2021

(54) Extrusion device having at least one perforated plate

(71) Applicant: KRAUSSMAFFEI EXTRUSION GMBH, Hannover (DE)

(72) Inventor: Frank Reineke, Ronnenberg (DE)

(21) Appl. No.: 17/041,556

(22) PCT Filed: Apr. 8, 2019
(86) PCT No.: PCT/EP2019/058770

§ 371 Date: Sep. 25, 2020

(30) Foreign Application Priority Data
Apr. 16, 2018 (DE) 10 2018 108 964.3

(51) Int. Cl. B29C 48/255; B29C 48/25; B29C 48/30; B29C 48/70; B29C 48/505

(52) U.S. Cl. CPC B29C 48/2556; B29C 48/2562; B29C 48/505; B29C 48/705; B29C 48/304

(57) ABSTRACT

An extrusion device including at least one extruder having a screw cylinder, a screw shaft rotatably supported in the screw cylinder and an extruder outlet, an injection mould having an outlet nozzle determining the cross-sectional contour of the extruder, and an extrusion head arranged between the extruder outlet of the at least one extruder and the outlet nozzle of the injection mould, wherein at least one perforated plate arranged in the extruder head is provided, which has a plurality of passage openings, wherein the passage openings are designed to dam up extrusion material conveyed from the at least one extruder through the passage openings of the perforated plate differently into at least one first region of the perforated plate and at least one second region of the perforated plate, in such a way that the extrusion material is partly diverted from its preferential direction within a central section of the perforated plate, specifically increasingly into at least one edge section of the perforated plate.

The invention relates to an extrusion device comprising at least one extruder having a screw cylinder, a screw shaft rotatably supported in the screw cylinder, and an extruder outlet, an injection mould having an outlet nozzle determining the cross-sectional contour of the extrudate, and an extrusion head arranged between the extruder outlet of the at least one extruder and the outlet nozzle of the injection mould.

From WO 2016/192988 A1 for example a tyre strip extrusion device for the production of treads and/or side strips for tyres is known, having a first extruder which has at least one first screw with a first screw longitudinal axis, a second extruder, which has at least one second screw with a second screw longitudinal axis, a third extruder which has at least one third screw with a third screw longitudinal axis, at least one fourth extruder, which has at least one fourth screw with a fourth screw longitudinal axis, and an extrusion head with a head housing which has at least four feed openings, which are connected with respectively an associated extruder for feeding extrusion material, and with an injection mould for forming an extrusion strand from the extrusion materials, which is connected with the head housing, has an outlet opening and is arranged so that extrusion material which is fed through the feed openings is able to be directed along a respective material path to the outlet opening.

It is an object of the invention to provide an extrusion device by which particularly uniform strand profiles can be produced.

The problem is solved by an extrusion device comprising at least one extruder having a screw cylinder, a screw shaft rotatably supported in the screw cylinder and an extruder outlet, an injection mould having an outlet nozzle determining the cross-sectional contour of the extrudate, and an extrusion head arranged between the extruder outlet of the at least one extruder and the outlet nozzle of the injection mould, wherein at least one perforated plate arranged in the extruder head is provided, which has (e.g. a plurality of) passage openings, wherein the passage openings are designed to dam up an extrusion material conveyed from the at least one extruder through the passage openings of the perforated plate differently in at least one first region of the perforated plate and at least one second region of the perforated plate, in such a way that the extrusion material is partly diverted from its preferential direction within a central section of the perforated plate, specifically increasingly into at least one edge section of the perforated plate.

By means of such a perforated plate, at least two different regions can be created in the cross-sectional area of the perforated plate, which respectively provide a different flow resistance to the extrusion material conveyed to the injection mould from the at least one extruder through the flow channel. Owing to a different ratio of cross-sections which are more easily able to be flowed through and of cross-sections which are more difficult to be able to be flowed through, created through the different flow resistances, which cross-sections for example can be determined by the cross-section size, the channel length and/or shape or respectively contour form of dam channels and/or passage openings of the perforated plate, the extrusion material can be pushed away from a preferential direction, occurring without such a perforated plate, within a central section of the flow channel, into the edge sections of the flow channel which are less preferred without such a perforated plate.

The perforated plate can be designed to divert the extrusion material into two edge sections of the flow channel, lying opposite at a central section of the flow channel, into a width of the flow channel and/or into a width of the outlet nozzle of the injection mould, which exceeds an extruder diameter of the at least one extruder associated with the flow channel.

Through the passage openings of the perforated plate, a plurality of first dam channels can be formed within the at least one first region, which dam channels are coordinated with one another with regard to their channel lengths and/or with regard to their channel cross-sectional areas in such a way that they have a greater flow resistance than second dam channels of the at least one second region, and within the at least one second region a plurality of the second dam channels are formed through the passage openings, which are coordinated with one another with regard to their channel lengths and/or with regard to their channel cross-sectional areas in such a way that they have a smaller flow resistance than the first dam channels of the at least one first region.

Longer channel lengths produce here a greater flow resistance than shorter channel lengths. Greater channel cross-sectional areas produce here a smaller flow resistance than smaller channel cross-sectional areas. A greater flow resistance can therefore be achieved within a region in that the channel cross-sectional areas are relatively smaller and/or the channel lengths are relatively longer than in other regions. A smaller flow resistance can be achieved accordingly within a region in that the channel cross-sectional areas are relatively greater and/or the channel lengths are relatively shorter than in other regions.

The at least one first region can have several first passage openings which in relation to the area of the first region in total have a shared first relative passage cross-sectional area, and the at least one second region can have several second relative passage openings which in relation to the area of the second region in total have a shared second passage cross-sectional area which is greater compared to the first relative passage cross-sectional area.

The passage openings are designed for flowing through with a material which is conveyed by the at least one extruder to the injection mould. By having at least one first region which has several first passage openings, which in relation to the area of the first region in total have a shared first relative passage cross-sectional area, and the perforated plate has at least one second region, which has several second relative passage openings which in relation to the area of the second region in total have a shared second passage cross-sectional area, which is greater compared to the first relative passage cross-sectional area, at least two different regions can be created in the cross-sectional area of the perforated plate, which provide respectively a different flow resistance to the material which is conveyed from the at least one extruder through the perforated plate to the injection mould. Through a different ratio of cross-sections which are able to be flowed through (plurality of passage openings) and cross-sections which are not able to be flowed through (connection webs of the perforated plate between the passage openings) within the respective region, and through the size and/or shape or respectively contour form of the passage openings, different flow resistances can be generated.

The several first passage openings and the several second passage openings with their individual cross-sections can all have the same geometric shape, wherein each of the first passage openings is configured smaller in the size of the shape than the size of the shape of each second passage opening.

The several first passage openings can preferably be respectively circular in cross-section with a first diameter, and the several second passage openings can be respectively circular in cross-section with a second diameter, wherein the second diameters of the second passage openings are greater than the first diameters of the first passage openings. Thus, the passage openings with circular cross-sections can be produced in a simple manner by drilling or punching.

The cross-sectional contour of the extrudate can have a maximum width which is greater than the maximum height of the cross-sectional contour of the extrudate, and the perforated plate can have in a central section of the width the first region which has the several first passage openings, and the perforated plate can have in the two opposite edge sections of the width, which border the central section, respectively a second region which have the several second passage openings.

When the cross-sectional contour of the extrudate has a maximum width which is greater than the maximum height of the cross-sectional contour of the extrudate, this can mean, for example in the case of rectangular or at least approximately rectangular profile cross-sections, that the extrudate forms a strip, as for example a track as semi-finished product for the production of tyres, in particular bicycle tyres or automobile tyres. Generally, the extrusion device and the perforated plate can be designed for the production of rubber profiles and/or elastomer profiles. Generally, the extrusion device and the perforated plates can be designed for the production of multi-layered rubber profiles and/or elastomer profiles of different material compositions. The profiles can generally have caoutchouc material.

By the perforated plate having in a central section of the width the first region which has the several first passage openings, and the perforated plate has in the two opposite edge sections of the width which border the central section respectively a second region, which have the several second passage openings, the material which is to be extruded can be diverted from its preferential direction within the central section, specifically increasingly into the two opposite edge sections of the width. This is particularly advantageous when for example the extruder outlets of the extruder(s) and/or the inlet openings of the extrusion head have a smaller cross-section than the width of the outlet nozzle of the injection mould or respectively the width of the extrusion profile which is to be manufactured.

The cross-sectional contour of the extrudate can have a maximum width which is greater than the maximum height of the cross-sectional contour of the extrudate, and the perforated plate can have here in all vertical positions first passage openings of equal size, and/or second passage openings of equal size. Thus, a controlled distribution of the material which is to be extruded can preferably be achieved over the width, in particular the greater width of the extrusion profile, wherein over the height, in particular the smaller height of the extrusion profile, no controlled distribution takes place.

The perforated plate can have a substantially rectangular basic shape, wherein an upper edge, codetermining the height of the perforated plate, is configured to be straight, a lower edge, codetermining the height of the perforated plate, is configured to be straight, and the two lateral edges, which determine the width of the perforated plate are respectively configured to be semi-circular. The respective perforated plate can in this respect have an at least approximately or precise oval contour. Thereby, the perforated plates can be positioned in a simple and quick manner and particularly accurately into the extrusion head, in particular inserted into the first head half and/or the second head half and/or removed or respectively exchanged.

In all embodiment variants, the at least one perforated plate can have a seat which is designed for supporting a screen. The perforated plate then forms in this respect a screen carrier for a screen. The screen can be designed for cleaning the extrusion material which is conveyed from the at least one extruder. The seat of the perforated late can be designed to support a flat screen on the perforated plate in such a way that the perforated plate forms a support body for the screen. The seat enables in particular a simple and quick exchanging of the screen, by the perforated plate being able to be removed from the extrusion head and by the screen being able to be removed from the perforated plate outside the extrusion head and a new and/or different screen being able to be inserted onto the perforated plate. Subsequently, the perforated plate which is provided with the new and/or different screen can be inserted into the extrusion head again.

The extrusion head can have a first head half which has two or more inlet openings, to which respectively an extruder outlet of an associated extruder of two or more extruders is connected, and which first head half has a number of through-openings corresponding to the number of inlet openings, wherein each through-opening has a seat for a perforated plate, and the extrusion head can have a second head half which has a number of exit openings corresponding to the number of through-openings of the first head half, wherein each exit opening has a seat for one of the perforated plates, and which second head half has at least one outlet opening to which the injection mould adjoins.

By means of such a divided extrusion head, the perforated plates can be designed separately as individual components and for example do not have to be incorporated in one piece in a first head half or a second head half of the extrusion head, so that different flow patterns for various injection moulds can be changed in a simple and favourably priced manner, wherein the extrusion head as such can itself be retained unchanged. In this respect, the perforated plates can be produced as separate structural elements and can be mounted in the extrusion head in an easily exchangeable manner.

Generally, the extrusion device according to the invention offers the advantage of a very compact, stable and pressure-resistant construction. Thus, injection heads can in particular also be created using corresponding screen inserts for example for the production of tyre profiles. Previous, horizontally divided injection heads, in particular tyre heads, are generally not pressure-resistant enough in order to enable the insertion of a screen. An extrusion head according to the invention can accordingly in particular be designed to be divided vertically.

The second head half can have a mount which is designed to receive the injection mould in a form-fitting manner. Thus, the injection moulds can also be changed in a simple and favourably priced manner, wherein the extrusion head as such can be itself retained unchanged.

The first head half and the second head half can be mounted adjustably with respect to one another, in such a way that the first head half and the second head half are movable so as to be separable from one another for the inserting of the at least one perforated plate and/or for the removing of the at least one perforated plate. For example, the first head half and the second head half can be connected in a foldable manner by means of a hinge arrangement.

There are shown:

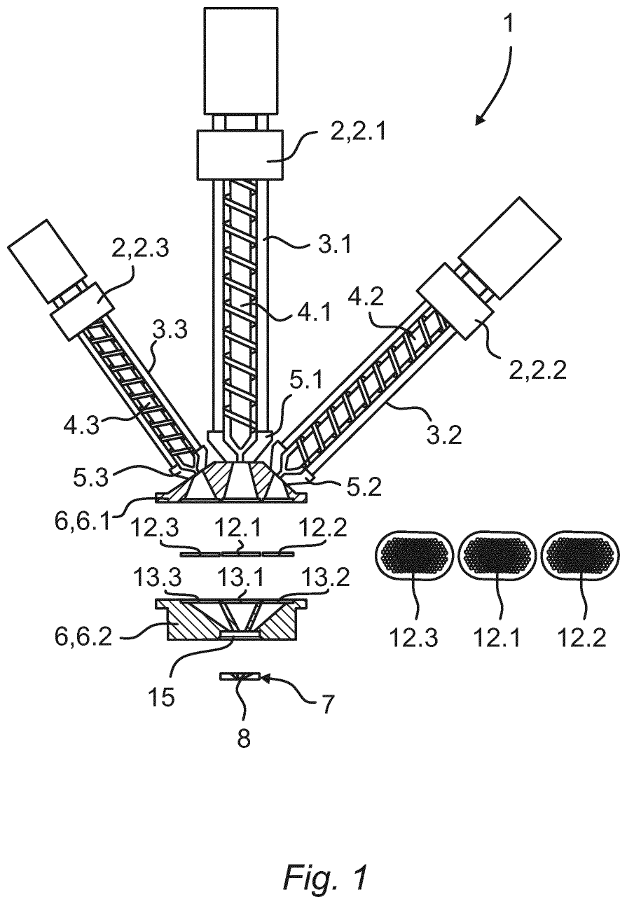

FIG. 1 a schematic illustration of an extrusion device with for example three extruders and three perforated plates,

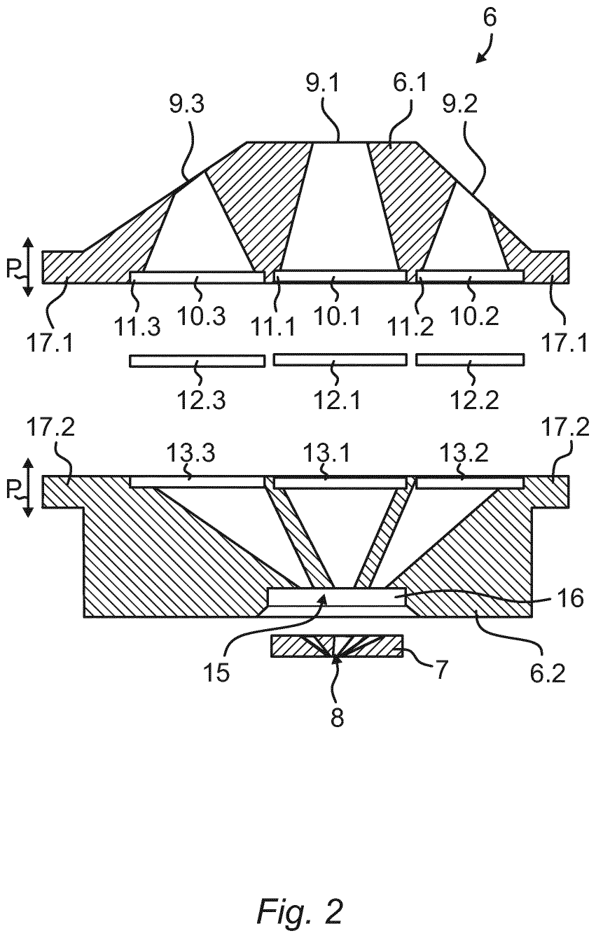

FIG. 2 a sectional illustration of an exemplary extrusion head with a first head half and a second head half, and the three perforated plates,

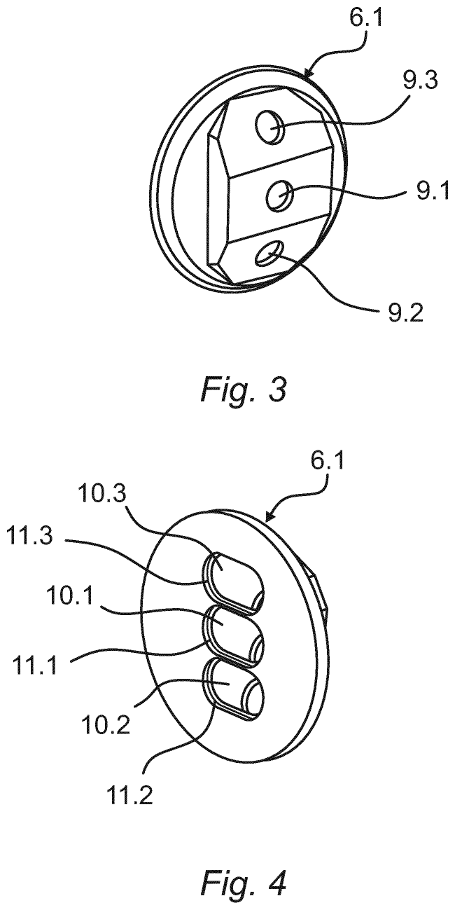

FIG. 3 a perspective illustration of the first head half according to FIG. 2 in a top view on three inlet openings, to which the three extruders are to be connected,

FIG. 4 a schematic illustration of the first head half according to FIG. 2 in a top view onto the rear side of the first head half, facing away from the three inlet openings, on which rear side three corresponding through-openings are arranged, with seats for the perforated plates,

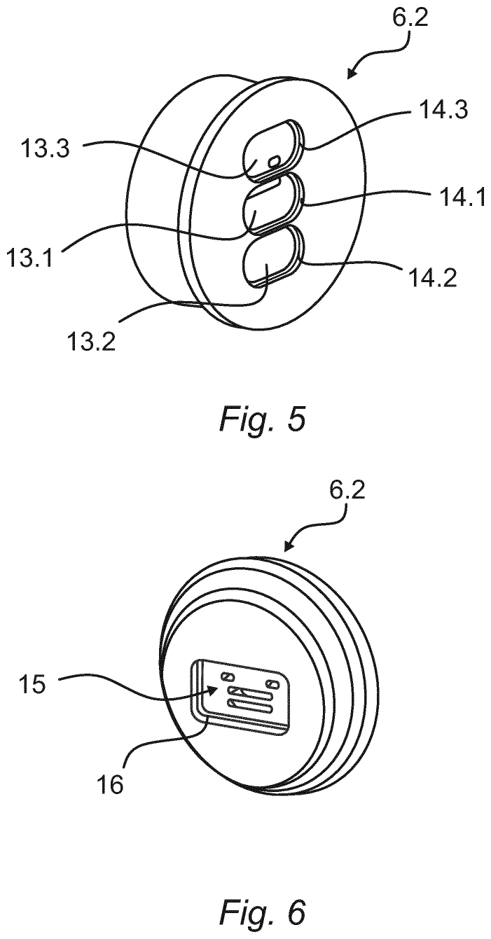

FIG. 5 a perspective illustration of the second head half according to FIG. 2 in a top view onto three corresponding exit openings with seats for the perforated plates,

FIG. 6 a schematic illustration of the second head half according to FIG. 2 in a top view onto the rear side of the second head half, facing away from the three exit openings, on which outlet openings are arranged, to which the injection mould adjoins, and

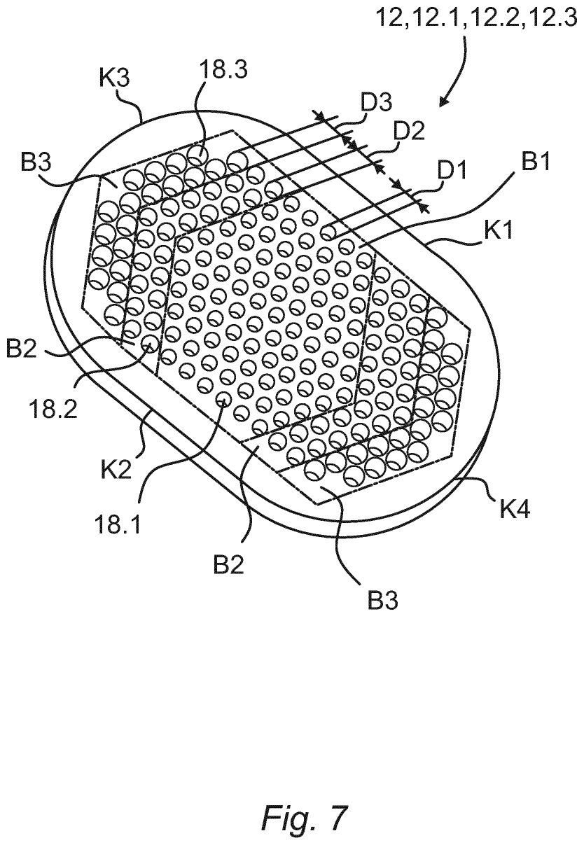

FIG. 7 a perspective schematic illustration of a representative example of a perforated plate according to the invention.

In FIG. 1 an exemplary extrusion device 1 is shown. The extrusion device 1 has at least one extruder 2, in the case of the present example embodiment three extruders 2.1, 2.2, 2.3, each of which is provided with a screw cylinder 3.1, 3.2, 3.3, a screw shaft 4.1, 4.2, 4.3, rotatably supported in the screw cylinder 3.1, 3.2, 3.3, and an extruder outlet 5.1., 5.2, 5.3. The three extruders 2.1, 2.2, 2.3 or respectively their extruder outlets 5.1, 5.2, 5.3 are connected at the input side to an extrusion head 6. The extrusion head 6 comprises a first head half 6.1 and a second head half 6.2.

The extrusion device 1 comprises in addition an injection mould 7 with an outlet nozzle 8 (FIG. 2) determining the cross-sectional contour of the extrudate. The extrusion head 6 is arranged between the extruder outlets 5.1, 5.2, 5.3 and the outlet nozzle 8 of the injection mould 7.

As can be seen in particular in FIG. 1 and FIG. 2, the extrusion head 6 has the first head half 6.1, which has two or more, in the case of the present example embodiment three inlet openings 9.1, 9.2, 9.3, to which respectively one of the extruder outlets 5.1, 5.2, 5.3 is connected. Accordingly, the first head half 6.1 has a number of through-openings 10.1, 10.2, 10.3 corresponding to the number of inlet openings 9.1, 9.2, 9.3. Each through-opening 10.1, 10.2, 10.3 has a seat 11.1, 11.2, 11.3 for a perforated plate 12.1, 12.2, 12.3.

The extrusion head 6 has in addition the second head half 6.2, which has a number of exit openings 13.1, 13.2, 13.3 corresponding to the number of through-openings 10.1, 10.2, 10.3 of the first head half 6.1, wherein each exit opening 13.1, 13.2, 13.3 has a seat 14.1, 14.2, 14.3 for one of the perforated plates 12.1, 12.2, 12.3. The second head half 6.2 has in addition at least one outlet opening 15, to which the injection mould 7 adjoins. Accordingly, the second head half 6.2 has a mount 16, which is configured to receive the injection mould 7 in a form-fitting manner.

The first head half 6.1 can have a first clamping flange 17.1 and the second head half 6.2 can have a second clamping flange 17.2, wherein the first clamping flange 17.1 and the second clamping flange 17.2 are designed to hold the first head half 6.1 with the second head half 6.2 together in a pressure-resistant manner by means of a mounted clamping clip (not illustrated), when at least one perforated plate 12.1, 12.2, 12.3 is inserted between the first head half 6.1 and the second head half 6.2.

The first head half 6.1 and the second head half 6.2 can be mounted adjustably with respect to one another, as indicated by the arrows P, in such a way that the first head half 6.1 and the second head half 6.2 are movable separably from one another for the inserting of the at least one perforated plate 12.1, 12.2, 12.3 and/or for removing the at least one perforated plate 12.1, 12.2, 12.3.

The first head half 6.1 is illustrated in FIG. 3 in a top view onto the three inlet openings 9.1, 9.2, 9.3, to which the three extruders 2.1, 2.2, 2.3 are to be connected.

The first head half 6.1 is illustrated in FIG. 4 in a top view onto the rear side of the first head half 6.1 facing away from the three inlet openings 9.1, 9.2, 9.3, on which rear side the three corresponding through-openings 10.1, 10.2, 10.3 are arranged, with the seats 11.1, 11.2, 11.3 for the perforated plates 12.1, 12.2, 12.3.

The second head half 6.2 is illustrated in FIG. 5 in a top view onto the three corresponding exit openings 13.1, 13.2, 13.3 with the seats 14.1, 14.2, 14.3 for the perforated plates 12.1, 12.2 12.3.

The second head half 6.2 is illustrated in FIG. 6 in a top view onto the rear side of the second head half 6.2, facing away from the three exit openings 13.1, 13.2, 13.3, on which rear side outlet openings 15 are arranged, to which the injection mould 7 adjoins.

In FIG. 7 a representative perforated plate 12.1, 12.2, 12.3 is shown in isolation. The perforated plate 12.1, 12.2, 12.3 comprises a plurality of passage openings 18.

In the case of the present example embodiment, the perforated plate 12.1, 12.2, 12.3 has a first region B1 which has several first passage openings 18.1, which in relation to the area of the first region B1 in total have a shared first relative passage cross-sectional area. The perforated plate 12.1, 12.2, 12.3 has in addition a second region B2 which comprises several second passage openings 18.2, which in relation to the area of the second region B2 in total have a shared second relative passage cross-sectional area which is greater compared to the first relative passage cross-sectional area. Furthermore, the perforated plate 12.1, 12.2, 12.3 in the case of the present example embodiment has a third region B3 which comprises several third passage openings 18.3, which in relation to the area of the second region B2 and of the first region B1 in total have a shared third relative passage cross-sectional area, which is greater compared to the first relative passage cross-sectional area and to the second relative passage cross-sectional area.

The several first passage openings 18.1 are respectively configured circular in cross-section with a first diameter D1, the several second passage openings 18.2 are respectively configured circular in cross-section with a second diameter D2, and the several third passage openings 18.3 are respectively configured circular in cross-section with a third diameter D3, wherein the second diameters D2 of the second passage openings 18.2 are greater than the first diameters D1 of the first passage openings 18.1, and wherein the third diameters D3 of the third passage openings 18.3 are greater than the second diameters D2 of the second passage openings 18.2.

In particular when the cross-sectional contour of the extrudate has a maximum width which is greater than the maximum height of the cross-sectional contour of the extrudate, the perforated plate 12.1, 12.2, 12.3, as illustrated in FIG. 7, can have in a central section of the width the first region B1, which has the several first passage openings 18.1, and the perforated plate 12.1, 12.2, 12.3 in the two opposite edge sections of the width, which border the central section, can respectively have a second region B2, which have the several second passage openings 18.2, and additionally at the edge regions of the region B2 have the further third passage openings 18.3. Here, the perforated plate 12.1, 12.2, 12.3, as illustrated in FIG. 7, can have in all vertical positions respectively first passage openings 18.1 of equal size, and second passage openings 18.2 of equal side, and third passage openings 18.3 of equal size.

The perforated plate 12.1, 12.2, 12.3 in the case of the present example embodiment has a substantially rectangular basic shape, wherein an upper edge K1, co-determining the height of the perforated plate 12.1, 12.2, 12.3 is configured to be straight, a lower edge K2 co-determining the height of the perforated plate 12.1, 12.2, 12.3 is configured to be straight, and the two lateral edges K3, K4, which determine the width of the perforated plate 12.1, 12.2, 12.3 are respectively configured to be semi-circular.

### LIST OF REFERENCE NUMBERS

1 extrusion device
2, 2.1, 2.2, 2.3 extruder
3.1, 3.2, 3.3 screw cylinder
4.1, 4.2, 4.3 screw shaft
5.1, 5.2, 5.3 extruder outlet
6 extrusion head
6.1 first head half
6.2 second head half
7 injection mould
8 outlet nozzle
9.1, 9.2, 9.3 inlet openings
10.1, 10.2, 10.3 through-openings
11.1, 11.2, 11.3 seat
12.1, 12.2, 12.3 perforated plate
13.1, 13.2, 13.3 exit openings
14.1, 14.2, 14.3 seat
15 outlet opening
16 mount
17.1 first clamping flange
17.2 second clamping flange
18 passage openings
B1 first region
B2 second region
B3 third region
18.1 first passage openings
18.2 second passage openings
18.3 third passage openings
D1 first diameters
D2 second diameters
D3 third diameters
K1 upper edge
K2 lower edge
K3, K4 lateral edges

What is claimed is:

1. An extrusion device comprising at least one extruder (2, 2.1, 2.2, 2.3) having a screw cylinder (3.1, 3.2, 3.3), a screw shaft (4.1, 4.2, 4.3) rotatably supported in the screw cylinder (3.1, 3.2, 3.3) and an extruder outlet (5.1, 5.2, 5.3), an injection mould (7) having an outlet nozzle (8) determining the cross-sectional contour of the extrudate, and an extrusion head (6) arranged between the extruder outlet (5.1, 5.2, 5.3) of the at least one extruder (2, 2.1, 2.2, 2.3) and the outlet nozzle (8) of the injection mould (7), with at least one perforated plate (12.1, 12.2, 12.3) arranged in the extrusion head (6), which has passage openings (18), wherein the passage openings (18) are designed to dam up an extrusion material conveyed from the at least one extruder (2, 2.1, 2.2, 2.3) through the passage openings (18) of the perforated plate (12.1, 12.2, 12.3) differently in at least one first region (B1) of the perforated plate (12.1, 12.2, 12.3) and at least one second region (B2) of the perforated plate (12.1, 12.2, 12.3), in such a way that the extrusion material is partly diverted from its preferential direction within a central section of the perforated plate (12.1, 12.2, 12.3), specifically increasingly into at least one edge section of the perforated plate (12.1, 12.2, 12.3), wherein the perforated plate (12.1, 12.2, 12.3) has a substantially rectangular basic shape, wherein an upper edge (K1) co-determining the height of the perforated plate (12.1, 12.2, 12.3) is configured to be straight, a lower edge (K2) co-determining the height of the perforated plate (12.1, 12.2, 12.3) is configured to be straight, and the two lateral edges (K3, K4), which determine the width of the perforated plate (12.1, 12.2, 12.3) are configured respectively to be semi-circular, wherein the cross-sectional contour of the extrudate has a maximum width which is greater than the maximum height of the cross-sectional contour of the extrudate, and the perforated plate (12.1, 12.2, 12.3) in a central section of the width has the first region (B1), which has the several first passage openings (18.1), and the perforated plate (12.1, 12.2, 12.3) in the two opposite edge sections of the width, which border the central section, has respectively a second region (B2), which have the several second passage openings (18.2).

2. The extrusion device according to claim 1,
wherein the perforated plate (12.1, 12.2, 12.3) is designed to divert the extrusion material into two opposite edge sections at a central section of the flow channel, into a width of the flow channel and/or into a width of the outlet nozzle (8) of the injection mould (7), which exceeds an extruder diameter of the at least one extruder (2, 2.1, 2.2, 2.3) associated with the flow channel.

3. The extrusion device according to claim 1,
wherein through the passage openings (18) of the perforated plate (12.1, 12.2, 12.3) within the at least one first region (B1) a plurality of first dam channels are formed, which with regard to their channel lengths and/or with regard to their channel cross-sectional areas are coordinated with one another in such a way that they have a greater flow resistance than second dam channels of the at least one second region (B2), and within the at least one second region (B2) a plurality of the second dam channels are formed through the passage openings (18), which with regard to their channel lengths and/or with regard to their channel cross-sectional areas are coordinated with one another in such a way that they have a smaller flow resistance than the first dam channels of the at least one first region (B1).

4. The extrusion device according to claim 1,
the at least one first region (B1) has several first passage openings (18.1), which in relation to the area of the first region (B1) in total have a shared first relative passage cross-sectional area and the at least one second region (B2; B3) has several second passage openings (18.2, 18.3), which in relation to the area of the second region (B2, B3) in total have a shared second relative passage cross-sectional area, which is greater compared to the first relative passage cross-sectional area.

5. The extrusion device according to claim 4,
wherein the several first passage openings (18.1) and the several second passage openings (18.2) with their individual cross-sections all have the same geometric shape, wherein each of the first passage openings (18.1) is configured smaller in the size of the shape than the size of the shape of each second passage opening (18.2).

6. The extrusion device according to claim 4,
wherein the several first passage openings (18.1) are respectively circular in cross-section with a first diameter (D1) and the several second passage openings (18.2) are respectively circular in cross-section with a second diameter (D2), wherein the second diameters (D2) of the second passage openings (18.2) are greater than the first diameters (D1) of the first passage openings (18.1).

7. (canceled)

8. The extrusion device according claim 1,
wherein the cross-sectional contour of the extrudate has a maximum width which is greater than the maximum height of the cross-sectional contour of the extrudate and the perforated plate (12.1, 12.2, 12.3) in all vertical positions has first passage openings (18.1) of equal size and/or second passage openings (18.2) of equal size.

9. (canceled)

10. The extrusion device according to claim 1,
wherein the several first passage openings (18.1) and the several second passage openings (18.2) are distributed substantially uniformly over the perforated plate (12.1, 12.2, 12.3).

11. The extrusion device according to claim 1,
wherein the at least one perforated plate (12.1, 12.2, 12.3) has a seat which is designed for supporting a screen.

12. The extrusion device according to claim 1,
wherein the extrusion head (6) has a first head half (6.1), which has two or more inlet openings (9.1, 9.2, 9.3) to which respectively an extruder outlet (5.1, 5.2, 5.3) of an associated extruder (2, 2.1, 2.2, 2.3) of two or more extruders (2, 2.1, 2.2, 2.3) is connected, and which first head half (6.1) has a number of through-openings (10.1, 10.2, 10.3) corresponding to the number of inlet openings (9.1, 9.2, 9.3), wherein each through-opening (10.1, 10.2, 10.3) has a seat (11.1, 11.2, 11.3) for a perforated plate (12.1, 12.2, 12.3), and that the extrusion head (6) has a second head half (6.2) which has a number of exit openings (13.1, 13.2, 13.3) corresponding to the number of through-openings (10.1, 10.2, 10.3) of the first head half (6.1), wherein each exit opening (13.1, 13.2, 13.3) has a seat (14.1, 14.2, 14.3) for one of the perforated plates (12.1, 12.2, 12.3), and which second head half (6.2) has at least one outlet opening (15) to which the injection mould (7) adjoins.

13. The extrusion device according to claim 10,
wherein the first head half (6.1) has a first clamping flange (17.1) and the second head half (6.2) has a second clamping flange (17.2), wherein the first clamping flange (17.1) and the second clamping flange (17.2) are designed to hold the first head half (6.1) with the second head half (6.2) together in a pressure-resistant manner by means of a mounted clamping clip, when at least one perforated plate (12.1, 12.2, 12.3) is inserted between the first head half (6.1) and the second head half (6.2).

14. The extrusion device according to claim 10,
wherein the first head half (6.1) and the second head half (6.2) are mounted adjustably with respect to one another, in such a way that the first head half (6.1) and the second head half (6.2) are movable separably from one another for inserting the at least one perforated plate (12.1, 12.2, 12.3) and/or for removing the at least one perforated plate (12.1, 12.2, 12.3).
